(19) United States
(12) Patent Application Publication
(10) Pub. No.: US 2026/0001363 A1
(43) Pub. Date: Jan. 1, 2026

(54) HOUSING UNIT AND RECORDING DEVICE

(71) Applicant: SEIKO EPSON CORPORATION, TOKYO (JP)

(72) Inventor: Kazuhito NODA, KITAKYUSHU-SHI (JP)

(21) Appl. No.: 19/250,257

(22) Filed: Jun. 26, 2025

(30) Foreign Application Priority Data
Jun. 27, 2024 (JP) 2024-103787

(51) Int. Cl. B41J 29/377; B41J 29/02; B41J 29/13; B41J 29/393

(52) U.S. Cl. CPC B41J 29/377; B41J 29/02; B41J 29/13; B41J 29/393

(57) ABSTRACT

The housing unit includes a frame, a blower part 51 attached to the frame, a control substrate that controls blower part; and a harness 71 extending along the frame and connected to the control substrate and the blower part, wherein the blower part includes a fan 52 and a duct 53 housing the fan, wherein the duct includes a forming portion 61 for forming a accommodation space 62 that houses a part of the harness together with the frame.

The present application is based on, and claims priority from JP Application Serial Number 2024-103787, filed June 27, 2024, the disclosure of which is hereby incorporated by reference herein in its entirety.

### BACKGROUND

### 1. Technical Field

The present disclosure relates to a housing unit and a recording device.

### 2. Related Art

JP-A-2005-119080 describes a recording device comprising a harness extending from an electrical component along a frame.

In this recording device, by arranging the harness along the frame, the possibility that the harness comes into contact with other components is reduced. In such a recording device, the harness may be provided with extra length. By providing extra length to the harness, an operator can easily pull out the harness from the housing. This improves the maintainability of the harness. On the other hand, when the harness has extra length, the harness is likely to lift up from the frame. Therefore, when the harness is provided with extra length, the harness may easily interfere with other components.

### SUMMARY

A housing unit that solves the above problem is a frame, a blower part attached to the frame, a control substrate that controls the blower part, and a harness extending along the frame and connected to the control substrate and the blower part, wherein the blower part includes a fan and a duct that houses the fan, wherein the duct includes a forming portion that forms an accommodation space that houses a part of the harness together with the frame.

A recording device that solves the above problem includes the housing unit and a recording section that is housed in the housing unit and that records an image on a medium.

### BRIEF DESCRIPTION OF THE DRAWINGS

FIG. 1 is a perspective view showing an example of a recording device.

FIG. 2 is a perspective view of the recording device from which a reading section has been removed.

FIG. 3 is a perspective view of the recording device with a first cover removed from FIG. 2.

FIG. 4 is a perspective view schematically showing a housing unit.

FIG. 5 is a view of the housing unit as viewed from a second direction.

FIG. 6 is a diagram of a duct.

FIG. 7 is an enlarged view of FIG. 3.

FIG.8 is a view of the housing unit from the opposite direction of a first direction.

FIG. 9 is a view in which a harness is separated from the state shown in FIG. 8.

FIG. 10 is a view in which the harness is separated from the state shown in FIG. 5.

FIG. 11 is a diagram showing a modification of the duct.

FIG. 12 is a perspective view of the housing unit including the duct shown in FIG.11.

### DESCRIPTION OF EMBODIMENTS

Hereinafter, an embodiment of a recording device including a housing unit will be described with reference to the drawings. The recording device is, for example, an ink jet type printer which records an image such as a character or a photograph by ejecting ink, which is an example of a liquid, onto a medium such as a paper sheet or fabric.

### Recording device

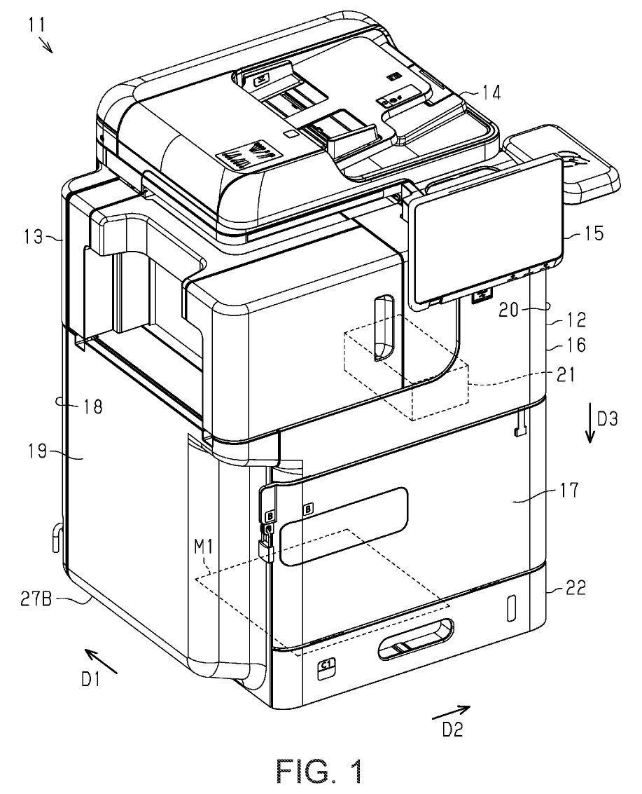

As shown in FIG. 1, the recording device 11 includes a device main body 12. The device main body 12 is configured to record an image on the medium M1. The device main body 12 will be described later. The recording device 11 may be a multifunction device having not only a function of recording an image on medium M1 but also other functions.

The recording device 11 may include a processing section 13. The processing section 13 may be a processing device detachable from the recording device 11. The processing section 13 is configured to perform processing on the medium M1 recorded by the device main body 12. The processing section 13 performs stapling, punching, and the like on the recorded medium M1, for example. The processing section 13 is mounted on the device main body 12. The processing section 13 is mounted on the upper portion of the device main body 12. The processing section 13 may hold or discharge the processed medium M1. The recording device 11 or the processing section 13 may include a discharge tray that receives the processed medium M1.

The recording device 11 may include a reading section 14. The reading section 14 is configured to read an image recorded on a document. The reading section 14 is a scanner. The reading section 14 sequentially reads an image by automatically feeding a set document. The reading section 14 is mounted on the device main body 12. The reading section 14 is mounted on an upper portion of the device main body 12. The reading section 14 is positioned above the processing section 13. The reading section 14 overlaps the device main body 12 when viewed from the vertical direction D3.

The recording device 11 includes an operation section 15. The operation section 15 is an interface for a user to operate the recording device 11. The operation section 15 is, for example, a touch panel. The operation section 15 may include a button, a lever, a switch, or the like. The operation section 15 is positioned in front of the device main body 12, the processing section 13, and the reading section 14.

### Device main body

The device main body 12 has a housing unit 16. The housing unit 16 houses various configurations of the device main body 12. The housing unit 16 is rectangular parallelepiped in shape. The housing unit 16 has a depth, a width, and a height. The depth of the housing unit 16 is the length of the housing unit 16 in a first direction D1. The width of the housing unit 16 is the length of the housing unit 16 in a second direction D2. The height of the housing unit 16 is the length of the housing unit 16 in the vertical direction D3. The first direction D1 is a direction different from the second direction D2 and the vertical direction D3. The first direction D1 is a direction from the front toward the back of the housing unit 16.

The second direction D2 is a direction different from the vertical direction D3. The second direction D2 is a direction from left to right when the housing unit 16 is viewed from the first direction D1. The first direction D1 and the second direction D2 indicate the directions in which the installation surface on which the device main body 12 is installed extends.

The device main body 12 has a recording section 21. The recording section 21 is configured to record an image on the medium M1. The recording section 21 records an image on the medium M1, for example, by ejecting a liquid onto the medium M1. In one example, the recording section 21 includes an elongated line head in the first direction D1. The recording section 21 is housed in the housing unit 16.

The housing unit 16 has multiple surfaces. The housing unit 16 has a front surface 17, a rear surface 18, a first side surface 19, and a second side surface 20. The front surface 17 is a surface facing in a direction opposite to the first direction D1 in the housing unit 16. In one example, the front surface 17 faces the same direction as the operation section 15. The front surface 17 is a surface facing a user who operates the recording device 11. The rear surface 18 is a surface of the housing unit 16 facing the first direction D1. The rear surface 18 is the opposite surface from the front surface 17. The front surface 17 and the rear surface 18 extend in the second direction D2 and the vertical direction D3. The first side surface 19 is a surface facing in a direction opposite to the second direction D2 in the housing unit 16. The second side surface 20 is a surface of the housing unit 16 facing the second direction D2. The second side surface 20 faces away from the first side surface 19. The second side surface 20 faces a direction different from the front surface 17, the rear surface 18, and the first side surface 19. The first side surface 19 and the second side surface 20 extend in the first direction D1 and the vertical direction D3.

The device main body 12 may have a stacking section 22. The stacking section 22 is configured to stack medium M1. In the stacking section 22, for example, a plurality of medium M1 are stacked in a stacked state. The stacking section 22 is stacked with medium M1 that has not been recorded on yet. The stacking section 22 is attached to the housing unit 16. The stacking section 22 is positioned at a lower portion in the housing unit 16. In one example, the stacking section 22 is configured to be insertable into and removable from the housing unit 16. The stacking section 22 is, for example, a cassette. The stacking section 22 can be inserted through and removed from the front surface 17. The user can replenish the medium M1 in the stacking section 22 by pulling out the stacking section 22 from the housing unit 16. The stacking section 22 is not limited to a cassette, and may be a tray. In addition to the recording section 21 and the stacking section 22, the device main body 12 may have a storage unit that stores a liquid, a transport unit that transports the medium M1, or the like.

### Housing unit

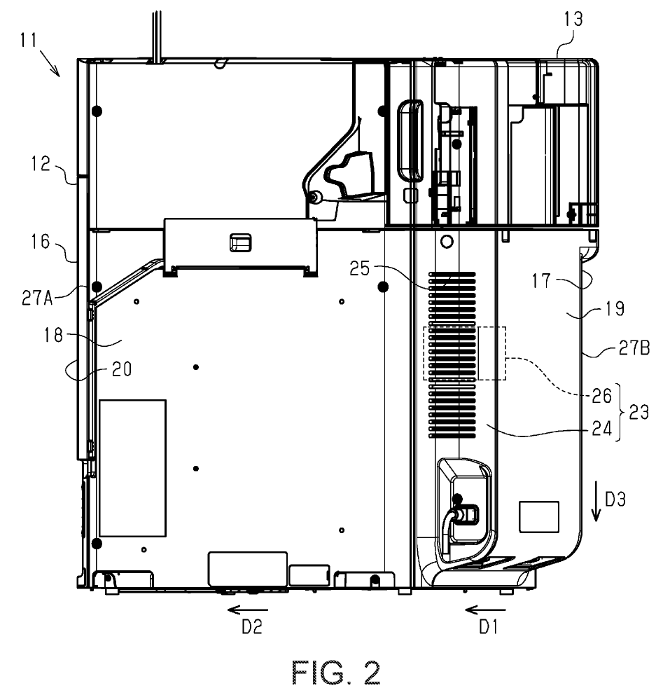

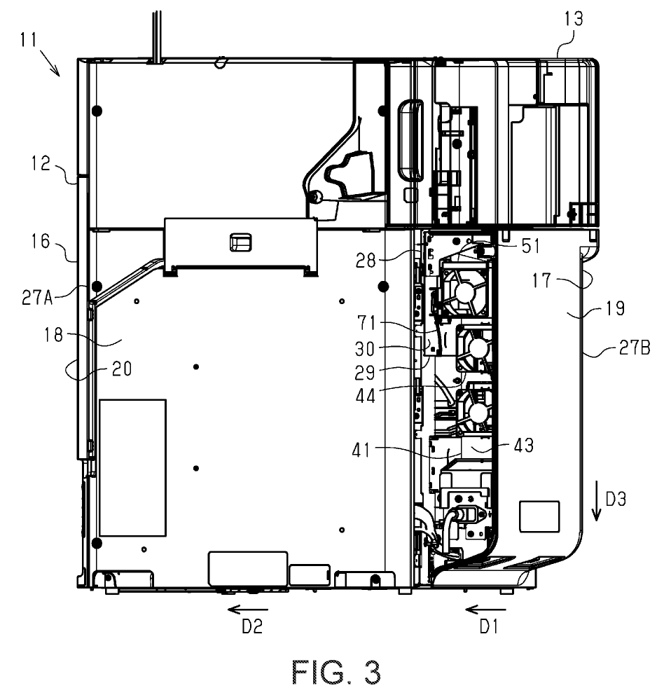

As shown in FIGS. 2 and 3, the housing unit 16 may have one or more covers. In one example, the housing unit 16 has a plurality of covers. The cover configures the exterior of the housing unit 16.

The housing unit 16 has a first cover 23. In one example, the first cover 23 configures the first side surface 19. The first cover 23 may form the rear surface 18 as well as the first side surface 19. The first cover 23 is configured to be detachable from the housing unit 16. When the first cover 23 is removed from the housing unit 16, the inside of the housing unit 16 is exposed. The operator performs maintenance inside the housing unit 16 by removing the first cover 23.

The first cover 23 has a cover member 24. The cover member 24 is a portion of the first cover 23 that constitutes the rear surface 18. Ventilation holes 25 are opened in the cover member 24. Specifically, the cover member 24 has ventilation holes 25 opened in it. 25 Through the ventilation holes 25, air can flow from the inside of the housing unit 16 to the outside of the housing unit 16, or air can flow from the outside of the housing unit 16 to the inside of the housing unit 16.

The first cover 23 has an opposing member 26. The opposing member 26 is a portion of the first cover 23 that is not exposed to the outside. The opposing member 26 extends from the cover member 24. Specifically, the opposing member 26 extends from the cover member 24 in a direction opposite to the first direction D1. The opposing member 26 is, for example, an air duct. The opposing member 26 communicates with a part of the ventilation holes 25. The opposing member 26 guides air from outside the housing unit 16 into the housing unit 16, or guides air from inside the housing unit 16 to outside the housing unit 16. The opposing member 26 is not limited to the air duct, and may be a member that simply protrudes from the cover member 24.

The housing unit 16 may have a second cover 27A. For instance, the second cover 27A forms the rear surface 18. Specifically, the second cover 27A constitutes the rear surface 18 with a larger area than the first cover 23. The second cover 27A is positioned adjacent to the first cover 23. The second cover 27A is configured to be detachable from the housing unit 16. When the second cover 27A is removed from the housing unit 16, the inside of the housing unit 16 is exposed. The operator performs maintenance on the housing unit 16 by removing the second cover 27A.

The housing unit 16 may have a third cover 27B. In one example, the third cover 27B constitutes the first side surface 19 together with the first cover 23. Specifically, the third cover 27B constitutes the first side surface 19 with a larger area than the first cover 23. The third cover 27B is positioned adjacent to the first cover 23. The third cover 27B is configured to be detachable from the housing unit 16. When the third cover 27B is removed from the housing unit 16, the inside of the housing unit 16 is exposed. The operator performs maintenance on the housing unit 16 by removing the third cover 27B.

The housing unit 16 may have a cover in addition to the first cover 23, the second cover 27A, and the third cover 27B.The housing unit 16 may have, for example, a cover constituting the front surface 17, or a cover constituting the second side surface 20. The housing unit 16 may be configured to allow an operator to access the inside of the housing unit 16 from the front, the side, or the like.

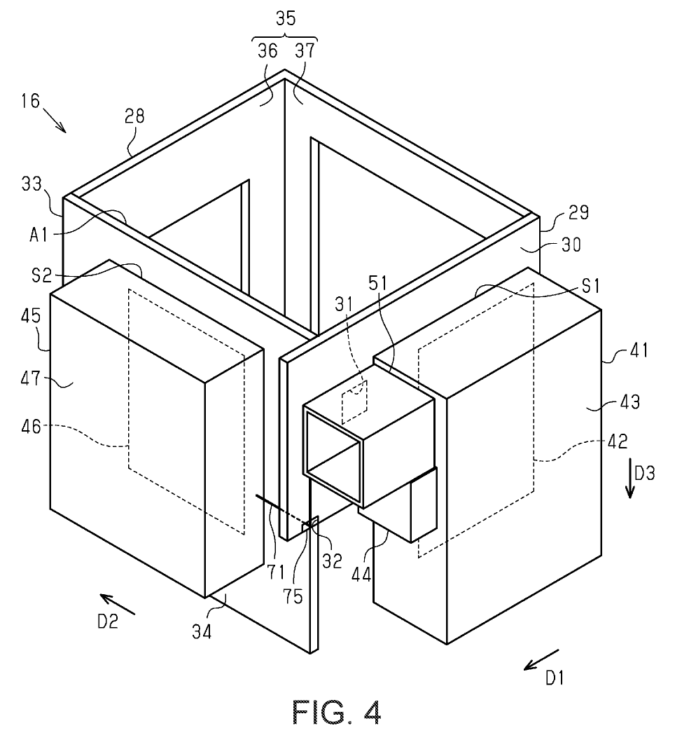

As shown in FIG. 4, the housing unit 16 has a frame section 28. The frame section 28 constitutes the frame of the housing unit 16. The frame section 28 is configured such that the covers such as the first cover 23, the second cover 27A, and the third cover 27B can be detachably attached. The frame section 28 houses various components of the device main body 12. In one example, the frame section 28 houses the recording section 21. The frame section 28 may house the stacking section 22. The frame section 28 has a rectangular parallelepiped shape. The frame section 28 is made of, for example, metal. By this, the rigidity of the housing unit 16 is ensured.

The frame section 28 defines a frame space A1. The frame space Al is a space surrounded by the frame section 28. The frame space Al is a space within the frame section 28. The recording section 21 is located in the frame space A1. The stacking section 22 may be located in the frame space Al

The frame section 28 has one or more frames. In one example, the frame section 28 has a plurality of frames. The covers such as the first cover 23, the second cover 27A, and the third cover 27B are attached to the frame. The frame is covered by the cover when the cover is attached to the frame.

The frame section 28 has a first frame 29. The first frame 29 defines the frame space A1. The first frame 29 is, for example, made of sheet metal. The first frame 29 is a plate extending in the first direction D1 and the vertical direction D3. In one example, the first frame 29 constitutes the left side wall of the frame section 28 when the housing unit 16 is viewed from the first direction D1.

The first frame 29 has an attachment surface 30. The attachment surface 30 is a surface of the first frame 29 facing outward from the housing unit 16. Specifically, the attachment surface 30 is a surface of the first frame 29 facing the opposite direction of the second direction D2.

A through hole 31 is opened in the first frame 29. Specifically, the attachment surface 30 has a through hole 31 opened in it. The through hole 31 is a groove, a hole, or the like. The through hole 31 communicates with the frame space A1. Therefore, the through hole 31 allows the frame space Al to communicate with the outside of the frame section 28. Through the through hole 31, air can flow from inside the frame section 28 to outside the frame section 28, or from inside the frame section 28 to outside the frame section 28.

A passageway 32 may be opened in the first frame 29. The passageway 32 may be opened in the attachment surface 30. The passageway 32 is a groove, a hole, or the like. The passageway 32 is formed, for example, so as not to communicate with the frame space A1. The passageway 32 is positioned so as to face the opposing member 26. Specifically, when viewed from the second direction D2 in a state in which the first cover 23 is attached, the passageway 32 is located so as to overlap with the opposing member 26. In one example, the passageway 32 is located below the through hole 31. The passageway 32 is formed at the lower end of the first frame 29.

The first frame 29 is covered by the first cover 23 and the third cover 27B. Specifically, when the first cover 23 and the third cover 27B are attached to the first frame 29, the first frame 29 is covered by the first cover 23 and the third cover 27B. When the first cover 23 and the third cover 27B are removed from the first frame 29, at least a part of the first frame 29 is exposed. The first frame 29 may be configured to hold the first cover 23 and the third cover 27B. The first frame 29 may be configured to hold the second cover 27A. The first cover 23 and the third cover 27B are not limited to a configuration in which they are directly attached to the first frame 29, and may be indirectly attached via a metal plate or the like. The second frame 33 has a holding surface 34. The holding surface 34 is a surface of the second frame 33 facing outward from the housing unit 16. Specifically, the holding surface 34 is a surface of the second frame 33 that faces the first direction D1.

The frame section 28 may have a second frame 33. The first frame 29 and the second frame 33 are joined to each other. The second frame 33 is attached to the first frame 29. The first frame 29 and the second frame 33 define the frame space A1. The second frame 33 is, for example, made of sheet metal. The second frame 33 is a plate extending in the second direction D2 and the vertical direction D3. The second frame 33 extends perpendicularly to the first frame 29. In one example, the second frame 33 constitutes a rear wall of the frame section 28 when the housing unit 16 is viewed in the first direction D1.

The second frame 33 is covered by the second cover 27A. Specifically, when the second cover 27A is attached to the second frame 33, the second frame 33 is covered by the second cover 27A. When the second cover 27A is removed from the second frame 33, the second frame 33 is exposed. The second frame 33 may be configured to hold the second cover 27A. The second frame 33 may be configured to hold the first cover 23.

The frame section 28 may have a third frame 35. The first frame 29, the second frame 33, and the third frame 35 are joined to each other. The third frame 35 is attached to the first frame 29. The third frame 35 is attached to the second frame 33. The third frame 35 connects the first frame 29 and the second frame 33. The third frame 35 is, for example, made of sheet metal.

The third frame 35 has a first portion 36 and a second portion 37. The first portion 36 is a portion that faces the first frame 29. The second portion 37 is a portion facing the second frame 33. The first portion 36 constitutes a right sidewall when the housing unit 16 is viewed from the first direction D1. The second portion 37 constitutes a front wall when the housing unit 16 is viewed from the first direction D1. The first portion 36 is a portion extending in the first direction D1 and the vertical direction D3. The second portion 37 is a portion extending in the second direction D2 and the vertical direction D3. The first portion 36 is attached to the second frame 33. The second portion 37 is attached to the first frame 29. The first portion 36 and the second portion 37 are fixed to each other.

The frame section 28 may have a frame in addition to the first frame 29, the second frame 33, and the third frame 35. The housing unit 16 may have, for example, a frame attached to the second frame 33 and the third frame 35, separately from the first frame 29.

The housing unit 16 has one or more substrate units. In one example, the housing unit 16 has a plurality of substrate units. Specifically, the housing unit 16 has two substrate units.

The housing unit 16 has a first substrate unit 41. The first substrate unit 41 is attached to frame section 28. In one example, the first substrate unit 41 is mounted to the first frame 29. The first substrate unit 41 may be attached to another frame.

The first substrate unit 41 is covered by the first cover 23 and the third cover 27B. Specifically, when the first cover 23 and the third cover 27B are attached to the first frame 29, the first substrate unit 41 is covered by the first cover 23 and the third cover 27B. When the first cover 23 and the third cover 27B are removed from the first frame 29, at least a part of the first substrate unit 41 is exposed.

The first substrate unit 41 has a power supply substrate 42. The power supply substrate 42 is a substrate that supplies electric power to electrical components included in the housing unit 16. In one example, the power supply substrate 42 supplies electric power to electrical components included in the recording device 11. The power supply substrate 42 supplies power to, for example, the processing section 13, the reading section 14, the operation section 15, the recording section 21, and the like. Since the power supply substrate 42 handles a large amount of electrical power, it is prone to becoming hot.

The power supply substrate 42 faces the first frame 29. The power supply substrate 42 is positioned to form the flow space S1. Since the air flows in the flow space S1, heat generated from the power supply substrate 42 is less likely to reach the frame space A1.

S1. The flow space S1 is a space in which air can flow between the first substrate unit 41 and the first frame 29. That is, the first substrate unit 41 is attached to the frame section 28 in a state spaced apart from the attachment surface 30.

The first substrate unit 41 has a power supply case 43. The power supply case 43 houses the power supply substrate 42. The power supply case 43 protects the power supply substrate 42. The power supply case 43 is, for example, in the shape of a rectangular parallelepiped. The power supply case 43 is attached to the frame section 28 so as to form the flow space S1. The first substrate unit 41 may have one or more power fans 44. The power fan 44 is attached to the power supply case 43. Specifically, the power fan 44 is attached to the surface of the power supply case 43 that is exposed when the first cover 23 is removed. In one example, the power fan 44 is attached to a surface of the power supply case 43 that faces the first direction D1.

The power fan 44 may be configured to exhaust air from the power supply case 43, or may be configured to take air into the power supply case 43. The power fan 44 is configured to cause air to flow between the inside and outside of the power supply case 43. In one example, the power fan 44 is configured to blow air from inside the power supply case 43 to the outside of the power supply case 43. By this, a temperature rise within the power supply case 43 is suppressed. As a result, the temperature rise of the power supply substrate 42 is suppressed.

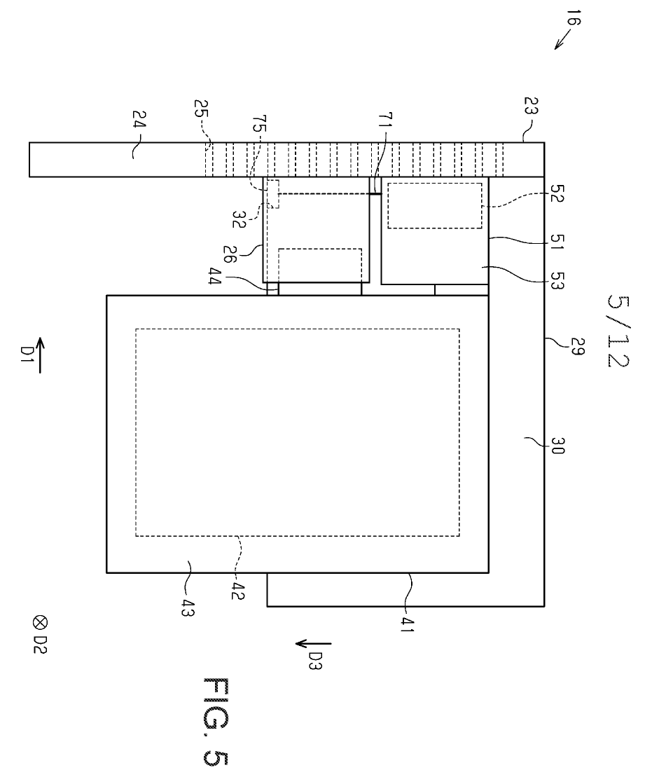

As shown in FIG. 5, an opposing member 26 is attached to the power fan 44. Specifically, in conjunction with the first cover 23 being attached to the first frame 29, the power fan 44 fits into the opposing member 26. When the first cover 23 is attached to the first frame 29, the opposing member 26 faces the attachment surface 30. When the first cover 23 is attached to the first frame 29, the power fan 44 is inserted into the opposing member 26. Therefore, the power fan 44 causes air to flow between the inside of the power supply case 43 and the outside of the housing unit 16 through the opposing member 26. In one example, the power fan 44 blows air from the inside of the power supply case 43 to the outside of the housing unit 16 through the opposing member 26. When the first cover 23 is removed, the power fan 44 is pulled out from the opposing member 26.

As shown in FIG. 4, the housing unit 16 has a second substrate unit 45. The second substrate unit 45 is attached to the frame section 28. In one example, the second substrate unit 45 is mounted to the second frame 33. The second substrate unit 45 may be attached to another frame.

The second substrate unit 45 is positioned outside the frame section 28. The second substrate unit 45 is positioned to face the second frame 33. The second substrate unit 45 is positioned to face the holding surface 34. The second substrate unit 45 may be positioned opposite the holding surface 34 so as to form an air space S2. The air space S2 is a space in which air is interposed between the second substrate unit 45 and the second frame 33. The air space S2 is a space in which air can flow between the second substrate unit 45 and the second frame 33. That is, the second substrate unit 45 may be attached to the frame section 28 in a state of being spaced apart from the holding surface 34. The second substrate unit 45 may be attached to the frame section 28 so as to be in contact with the holding surface 34 The second substrate unit 45 is covered by the second cover 27A. Specifically, the second cover 27A is attached to the second frame 33. The second substrate unit 45 is covered by the second cover 27A. When the second cover 27A is removed from the second frame 33, the second substrate unit 45 is exposed.

The second substrate unit 45 has a control substrate 46. The control substrate 46 is a substrate that controls the electrical components of the housing unit 16. In one example, the control substrate 46 supplies electric power to the electrical components included in the recording device 11. The control substrate 46 controls, for example, the processing section 13, the reading section 14, the operation section 15, the recording section 21, and the like. The control substrate 46 is connected to power supply substrate 42. The control substrate 46 controls various configurations based on the electric power supplied from the power supply substrate 42. The control substrate 46 is also prone to become hot due to heat generation. However, since the control substrate 46 handles less electric power than the power supply substrate 42, the control substrate 46 may be less likely to become hot than the power supply substrate 42.

The control substrate 46 faces the second frame 33. The control substrate 46 is positioned to form an air space S2 between it and the holding surface 34. Since air is interposed in the air space S2, heat generated from the control substrate 46 is less likely to reach the frame space A1.

The second substrate unit 45 has a control case 47. The control case 47 houses the control substrate 46. The control case 47 protects the control substrate 46. In one example, the control case 47 is in the shape of a rectangular parallelepiped. The control case 47 is attached to the frame section 28 so as to form the air space S2.

The housing unit 16 has a blower part 51. The blower part 51 is configured to cause air to flow in the frame space A1. The blower part 51 is controlled by the control substrate 46. The blower part 51 is configured to blow air from outside of the frame space Al into the frame space A1, or to blow air from the frame space Al to the outside of the frame space A1. By this, the frame space Al is ventilated. The blower part 51 reduces the risk of the frame space Al becoming hot. For example, the possibility that frame space Al will become hot due to heat generated from the substrate unit is reduced.

The blower part 51 is attached to the frame section 28. Specifically, the blower part 51 is attached to the first frame 29. The blower part 51 is attached to the attachment surface 30. The blower part 51 is attached to the attachment surface 30 so as to cover the through hole 31. The blower part 51 is configured to cause air to flow between the frame space Al and the outside of the frame space Al through the through hole 31. The blower part 51 may be configured to blow air from the frame space Al to the outside of the frame space Al through the through hole 31, or may be configured to blow air from the outside of the frame space Al into the frame space A1.

As shown in FIG. 5, the blower part 51 is attached to the first frame 29 so as to face the first cover 23. Specifically, the blower part 51 is attached to the first frame 29 so as to face the cover member 24. The blower part 51 causes air to flow between the frame space Al and the outside of the housing unit 16 through the ventilation holes 25 and the through hole 31. The blower part 51 may, through the ventilation holes 25 and the through hole 31, blow air from the frame space Al to the outside of the housing unit 16 or may blow air from the outside of the housing unit 16 to the frame space A1.

The blower part 51 is positioned adjacent to the opposing member 26. In one example, the blower part 51 is positioned adjacent to the opposing member 26 in the vertical direction D3. The blower part 51 is, for example, positioned directly above the opposing member 26 when the first cover 23 is attached to the first frame 29.

The blower part 51 has a fan 52. The fan 52 rotates by being driven. By this, air flows between the frame space Al and the outside of the housing unit 16 through the ventilation holes 25. In one example, the fan 52 is driven to exhaust air from the frame space Al to the outside of the housing unit 16. The fan 52 is controlled by the control substrate 46. For example, by the applied voltage of fan 52 being duty-controlled, the rotational speed of fan 52 is controlled.

The blower part 51 has a duct 53. The duct 53 houses the fan 52. The duct 53 is attached to the first frame 29. The duct 53 is attached to the attachment surface 30. The duct 53 communicates with the frame space A1. The duct 53 guides the air caused to flow by the fan 52. The duct 53 guides air between the first frame 29 and the first cover 23. The duct 53 guides air between the through hole 31 and the ventilation holes 25. In one example, the duct 53 guides the air from the through hole 31 toward the ventilation holes 25.

The duct 53 is positioned adjacent to the opposing member 26. More specifically, the duct 53 is adjacent to the opposing member 26 by the first cover 23 being attached to the first frame 29. In one example, the duct 53 is positioned to be adjacent to the opposing member 26 in the vertical direction D3. The duct 53 is positioned, for example, directly above the opposing member 26.

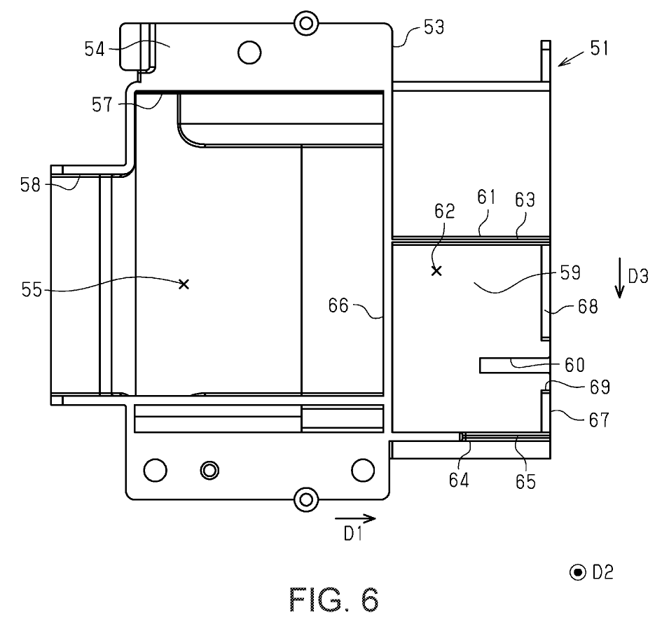

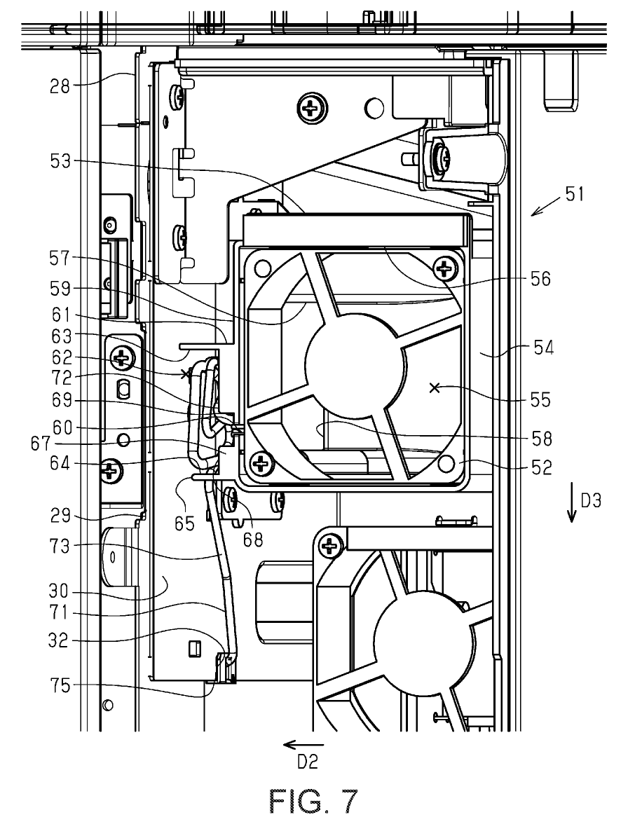

As shown in FIGS. 6 and 7, the duct 53 has an accommodation section 54. The accommodation section 54 is a portion that houses the fan 52 therein. The accommodation section 54 is attached to the first frame 29. Specifically, the accommodation section 54 is mounted to the attachment surface 30. The accommodation section 54 is mounted so as to face the through hole 31. The accommodation section 54 is attached so as to cover the through hole 31 when viewed from the second direction D2.

The accommodation section 54 defines a flow path 55. The fan 52 is positioned in the middle of the flow path 55. The flow path 55 guides the air flowing by the fan 52. The flow path 55 extends from the through hole 31 toward the ventilation holes 25.

A plurality of openings are formed in the accommodation section 54. In detail, a first opening 56 and a second opening 57 are provided in the accommodation section 54. The first opening 56 and the second opening 57 are in communication with the flow path 55. The first opening 56 is an opening communicating with the ventilation holes 25. The first opening 56 opens toward the first direction D1 in the accommodation section 54. The second opening 57 is an opening that communicates with the through hole 31. The second opening 57 opens in the second direction D2 in the accommodation section 54.

A third opening 58 may be formed in the accommodation section 54. The third opening 58 communicates with the flow path 55. The third opening 58 communicates with the second opening 57. The third opening 58 is opened in the accommodation section 54 in a direction opposite to the first direction D1. The third opening 58 communicates with the flow space S1. Therefore, when the fan 52 is driven, air flows in flow space S1. In one example, when the fan 52 is driven, air flows from the flow space S1 to the duct 53.

The accommodation section 54 has an opposite wall 59. The opposite wall 59 is a wall of the accommodation section 54 facing the first frame 29. The opposite wall 59 faces the attachment surface 30. The opposite wall 59 is a wall defining the flow path 55.

A connection port 60 is opened in the opposite wall 59. The connection port 60 communicates with the flow path 55. The inside of the accommodation section 54 communicates with the outside of the accommodation section 54 through the connection port 60. The connection port 60 is, for example, a slit. The fan 52 is connected to the control substrate 46 through the connection port 60.

The duct 53 has a forming portion 61. The forming portion 61 is provided outside the accommodation section 54. In one example, the forming portion 61 is adjacent to the first frame 29. Specifically, the forming portion 61 is positioned between the first frame 29 and the accommodation section 54. The forming portion 61 is adjacent to the accommodation section 54. The forming portion 61 extends from the accommodation section 54. The forming portion 61 extends from the accommodation section 54 so as to approach the first frame 29. The forming portion 61 extends from the opposite wall 59 so as to approach the attachment surface 30.

The forming portion 61 is a portion that forms an accommodation space 62. The accommodation space 62 is a space formed between the first frame 29 and the accommodation section 54. That is, the accommodation space 62 is a space outside the accommodation section 54. Therefore, the accommodation space 62 is less likely to interfere with the air flow in the flow path 55. The accommodation space 62 communicates with the flow path 55 through the connection port 60.

The forming portion 61 has a plurality of side walls. The forming portion 61 has a first side wall 63 and a second side wall 64. The first side wall 63 extends from the opposite wall 59 so as to approach the first frame 29. In one example, the first side wall 63 extends to contact the attachment surface 30. The first side wall 63 extends so as not to form a gap between the first side wall 63 and the attachment surface 30. The second side wall 64 extends from the opposite wall 59 so as to approach the first frame 29. In one example, the protruding amount of the second side wall 64 is smaller than the protruding amount of the first side wall 63. The second side wall 64 includes a portion that does not contact the attachment surface 30. The second side wall 64 extends to form a gap between the second side wall 64 and the attachment surface 30. By this, an adjacent port 65 is formed between the second side wall 64 and the attachment surface 30. The adjacent port 65 is an opening that communicates with the accommodation space 62. In the entire second side wall 64, the protruding amount may be equal to or greater than the protruding amount of the first side wall 63. At least the protruding amount of the portion where the adjacent port 65 is formed may be smaller than the protruding amount of the first side wall 63. The first side wall 63 and the second side wall 64 are side walls that face each other. In one example, the first side wall 63 and the second side wall 64 face each other in the vertical direction D3. The first side wall 63 is positioned above the second side wall 64. The first side wall 63 and the second side wall 64 define the accommodation space 62.

The forming portion 61 may have a third side wall 66 and a fourth side wall 67. The third side wall 66 extends from the opposite wall 59 so as to approach the first frame 29. In one example, the third side wall 66 extends to contact the attachment surface 30. The third side wall 66 extends so as not to form a gap between the third side wall 66 and the attachment surface 30. The third side wall 66 is also a wall defining the first opening 56. The fourth side wall 67 extends from the opposite wall 59 so as to approach the first frame 29. In one example, the protruding amount of the fourth side wall 67 is smaller than the protruding amount of the first side wall 63, the protruding amount of the second side wall 64, and the protruding amount of the third side wall 66. The fourth side wall 67 includes a portion that does not contact the attachment surface 30. The fourth side wall 67 extends so as to form a gap between itself and the attachment surface 30.

By this, the fourth side wall 67 forms an insertion port 68 between the fourth side wall 67 and the attachment surface 30. The insertion port 68 is an opening that communicates with the accommodation space 62. The insertion port 68 communicates with the adjacent port 65. The insertion port 68 is an opening with a larger area than the adjacent port 65, the connection port 60, and the like. A continuous port 69 may be opened in the fourth side wall 67. The continuous port 69 is a recess in the fourth side wall 67. The continuous port 69 is formed to communicate with the connection port 60. The continuous port 69 is formed to communicate with the insertion port 68.

The third side wall 66 and the fourth side wall 67 are side walls that face each other. In one example, the third side wall 66 and the fourth side wall 67 face each other in the first direction D1. The fourth side wall 67 is positioned more in the first direction D1 than the third side wall 66. The third side wall 66 and the fourth side wall 67 define the accommodation space 62. The first side wall 63, the second side wall 64, the third side wall 66, and the fourth side wall 67 define the accommodation space 62.

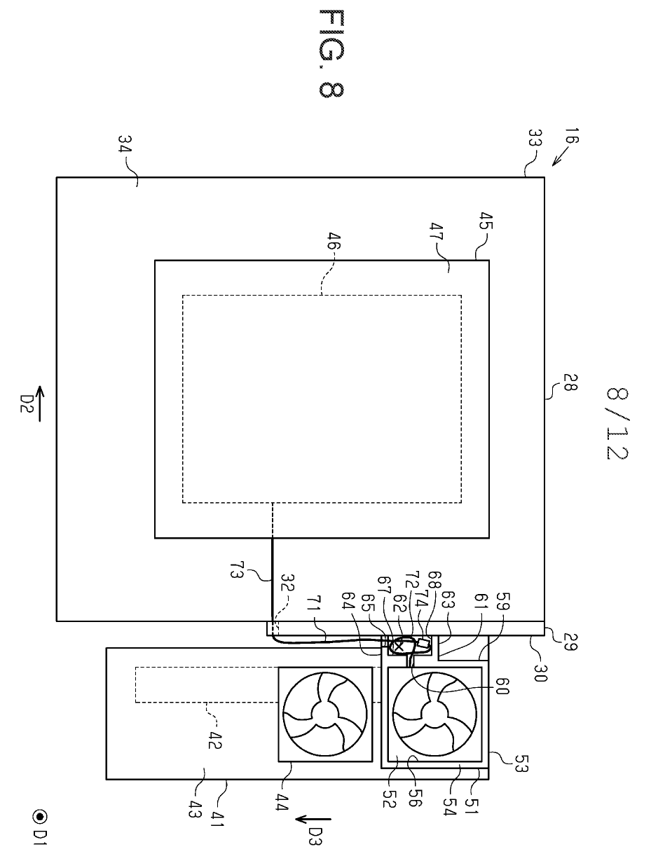

As shown in FIGS. 7 and 8, the housing unit 16 has a harness 71. The harness 71 is connected to the control substrate 46. The harness 71 is connected to the blower part 51. Specifically, the harness 71 is connected to the fan 52. The harness 71 transmits a control signal output from the control substrate 46 to the fan 52.

The harness 71 extends from the control substrate 46. The harness 71 extends along the second frame 33. Specifically, the harness 71 extends from the control substrate 46 along the holding surface 34. The harness 71 passes through the passageway 32. The harness 71 may extend, for example, so as to bypass the edge of the first frame 29 without passing through the passageway 32.

The harness 71 extends along the first frame 29. In particular, the harness 71 extends along the attachment surface 30. In one example, the harness 71 extends from the passageway 32 along the attachment surface 30. The harness 71 extends from the passageway 32 toward the blower part 51. Specifically, the harness 71 extends from the passageway 32 toward the accommodation space 62.

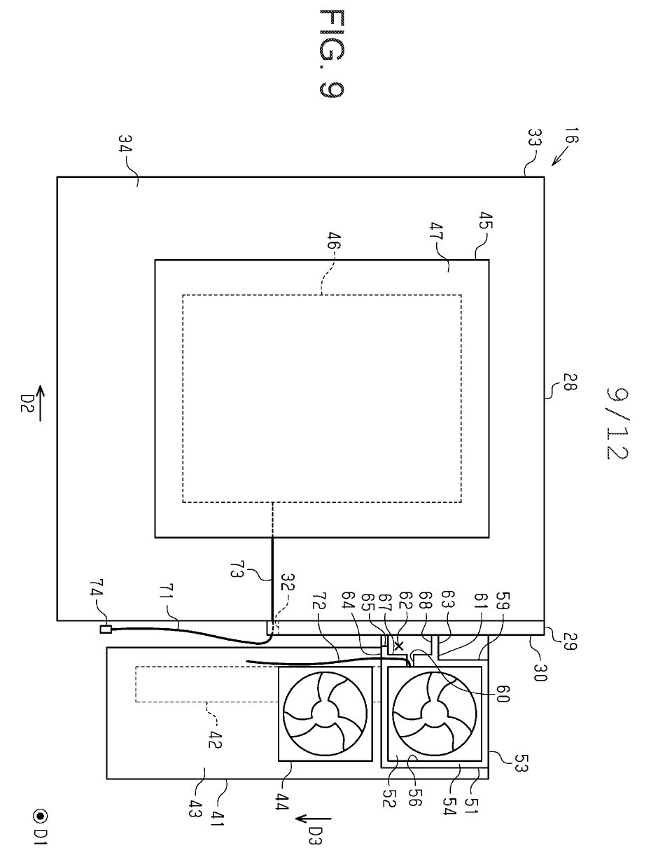

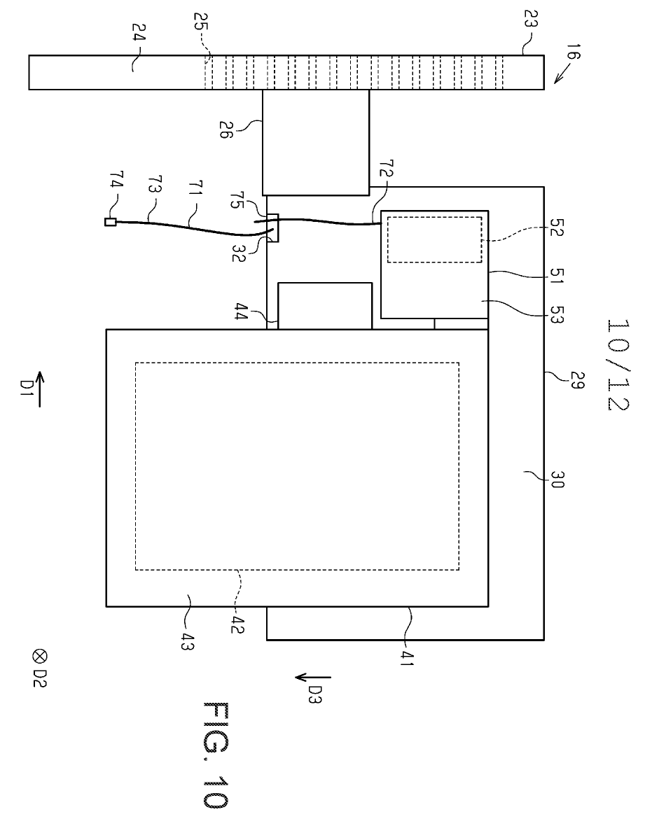

A part of the harness 71 is housed in the accommodation space 62. The harness 71 extends through the accommodation space 62. The harness 71 extends from the outside of the duct 53 to the accommodation space 62 by passing through the adjacent port 65. The harness 71 extends from the accommodation space 62 to the flow path 55 by passing through the connection port 60. In this way, the harness 71 is connected to the fan 52. As shown in FIGS. 8, 9, and 10, the harness 71 has a first cable 72 and a second cable 73. The first cable 72 extends from fan 52. The first cable 72 may be configured to be detachable with respect to the fan 52. The second cable 73 extends from the control substrate 46. The second cable 73 may be configured to be detachable from the control substrate 46. By the first cable 72 and the second cable 73 being connected to each other, the fan 52 is connected to the control substrate 46. The first cable 72 and the second cable 73 each include, for example, a conducting wire and a terminal.

The first cable 72 extends from the fan 52 to pass through connection port 60.

By this, the first cable 72 is held by the opposite wall 59. The first cable 72 is connected in the accommodation space 62 to the second cable 73.

The second cable 73 extends so as to pass through the passageway 32 from the control substrate 46. The second cable 73 extends from the passageway 32 along the attachment surface 30. The second cable 73 extends between the first frame 29 and the power fan 44. When the first cover 23 is attached to the first frame 29, the second cable 73 extends between the first frame 29 and the opposing member 26.

The second cable 73 extends so as to pass through the adjacent port 65. At this time, the second cable 73 is pressed by the second side wall 64. The second cable 73 is pressed by the second side wall 64. By this, the second cable 73 is less likely to rise up from the first frame 29 from the passageway 32 to the adjacent port 65. By this, the second cable 73 extends along the attachment surface 30. As a result, the risk of the second cable 73 interfering with other members, in particular, the opposing member 26, the power fan 44, and the like, is reduced.

The harness 71 has a relay connector 74. The relay connector 74 is a connector that connects the first cable 72 and the second cable 73 to each other. The relay connector 74 is connected to the first cable 72. The relay connector 74 is connected to second cable 73. Specifically, the relay connector 74 is connected to the terminal of the first cable 72 and the terminal of the second cable 73. The first cable 72 and the second cable 73 may be directly connected without passing through the relay connector 74. The relay connector 74 is housed in the accommodation space 62. The accommodation space 62 has a volume capable of housing the relay connector 74.

The first cable 72 and the second cable 73 are separated during maintenance of the blower part 51. For example, when the operator performs maintenance on the blower part 51, the operator removes the first cover 23 from the first frame 29. At this time, the operator may remove the third cover 27B together with the first frame 29. The operator accesses the inside of the housing unit 16 to separate the first cable 72 and the second cable 73. In the housing unit 16, the harness 71 is configured to have an extra length so that the operator can easily separate the first cable 72 and the second cable 73. Since the harness 71 has extra length, the operator can pull out the harness 71 from the inside of the housing unit 16 to the outside of the housing unit 16. In one example, the harness 71 has extra length so that the relay connector 74 can be pulled out toward the outside of the housing unit 16.

If the harness 71 has extra length, it becomes difficult for the harness 71 to fit in the housing unit 16. In this case, the harness 71 is likely to interfere with other components. For example, the harness 71 is likely to interfere with the opposing member 26. In particular, when the first cover 23 is attached to the first frame 29, the harness 71 is likely to be sandwiched between the opposing member 26 and the first substrate unit 41. In this case, there is a possibility that the harness 71 may be damaged.

The operator, after connecting the first cable 72 and the second cable 73 to each other, pushes the harness 71 into the accommodation space 62. That is, the operator pushes the extra length portion of the harness 71 into the accommodation space 62. Specifically, the operator pushes the relay connector 74, the first cable 72, and the second cable 73 into the accommodation space 62 through the insertion port 68. The operator pushes the first cable 72 into the accommodation space 62 so that the first cable 72 passes through the connection port 60. The operator pushes the second cable 73 into the accommodation space 62 so that the second cable 73 passes through the adjacent port 65. In this manner, the excess length portion of the harness 71 is housed in the accommodation space 62. The extra length portion of the harness 71 is housed in the accommodation space 62 in a curved state. This reduces the risk of the harness 71 interfering with other components.

There is risk that the harness 71 may be deformed so as to expand in the accommodation space 62 by reaction force. On the other hand, the fourth side wall 67 presses the harness 71. Therefore, the harness 71 is unlikely to spring out from the accommodation space 62.

The housing unit 16 may have a clamp 75. The clamp 75 holds the harness 71. In one example, the clamp 75 holds the second cable 73. The clamp 75 is attached to the first frame 29. The clamp 75 is attached so as to be housed in the passageway 32. By this, the second cable 73 can be suppressed from rubbing against the passageway 32. The second cable 73 is less likely to become slack between the control substrate 46 and the first frame 29. For example, the second cable 73 tends to extend along the holding surface 34 toward the passageway 32 from the control substrate 46.

The clamp 75 is not limited to being attached to the first frame 29, and the relay connector 74 may also be attached to the first frame 29. For example, the relay connector 74 may be attached so as to fit into the passageway 32. In this case, the first cable 72 extends along the attachment surface 30 toward the passageway 32 from the adjacent port 65. The harness 71 is configured such that the first cable 72 has extra length. The extra length portion of the first cable 72 is housed in the accommodation space 62. A relay connector different from the relay connector 74 may be attached to the first frame 29. In this case, the harness 71 may have a cable connected to the relay connector and the relay connector 74, apart from the first cable 72 and the second cable 73.

The clamp 75 may be provided in a portion other than the passageway 32. In one example, by providing a clamp between the passageway 32 and the accommodation space 62, the second cable 73 can be less likely to sag between the control substrate 46 and the first frame 29. For example, the second cable 73 more easily extends along the attachment surface 30 toward the adjacent port 65 from the passageway 32.

### Operation and effect of embodiment

Next, the operation and effects of the above embodiment will be described.

(1) The forming portion 61 forms the accommodation space 62 that houses a part of the harness 71. According to the above configuration, since the extra length portion of the harness 71 is housed in the accommodation space 62, the harness 71 can easily extend along the first frame 29. This reduces the risk of the harness 71 interfering with other components. Since the accommodation space 62 is formed by a part of the duct 53 without using any member such as a clamp, the number of parts can be suppressed and the configuration can be simplified.

(2) The forming portion 61 is provided outside the accommodation section 54. According to the above configuration, since the accommodation space 62 is a space outside the accommodation section 54, the air flowing by the fan 52 is unlikely to flow into the accommodation space 62. Therefore, the risk that the harness 71 will affect the air flow can be reduced.

(3) The protruding amount of the second side wall 64 is smaller than the protruding amount of the first side wall 63. According to the above configuration, the harness 71 can enter the accommodation space 62 through a space between the second side wall 64 and the first frame 29. At this time, the second side wall 64 presses the harness 71. Since the second side wall 64 presses the harness 71, the harness 71 is less likely to rise up from the first frame 29.

(4) The opposing member 26 faces the attachment surface 30 when the first cover 23 is attached to the first frame 29. According to the above configuration, the harness 71 is less likely to rise from the first frame 29, thereby reducing the possibility that the harness 71 interferes with the opposing member 26. In particular, when the first cover 23 is attached to the first frame 29, the risk of the harness 71 coming into contact with the opposing member 26 is reduced.

(5) The opposing member 26 is positioned so as to face the passageway 32. According to the above configuration, even when the harness 71 extends between the first frame 29 and the opposing member 26, the operator can easily perform maintenance on the harness 71 by pulling the harness 71 out of the accommodation space 62.

(6) The forming portion 61 has the fourth side wall 67. According to the above configuration, the fourth side wall 67 reduces the risk of the harness 71 springing out from the accommodation space 62. The protruding amount of the fourth side wall 67 is smaller than the protruding amount of the first side wall 63, the protruding amount of the second side wall 64, and the protruding amount of the third side wall 66. According to the above configuration, the harness 71 can be easily housed the in the accommodation space 62.

(7) The accommodation space 62 has a volume capable of housing the relay connector 74. According to the above configuration, the operator can easily perform maintenance on the harness 71 by pulling out the relay connector 74 from the accommodation space 62.

(8) The duct 53 communicates with the frame space A1. According to the above configuration, the risk of the frame space Al becoming hot can be reduced.

(9) The duct 53 communicates with the flow space A1. According to the above configuration, the fan 52 can cause the air in the flow space S1.

### Modifications

The above-described embodiments may be modified as follows. The above-described embodiments and the following modifications can be implemented in combination with each other to the extent that there is no technical contradiction.

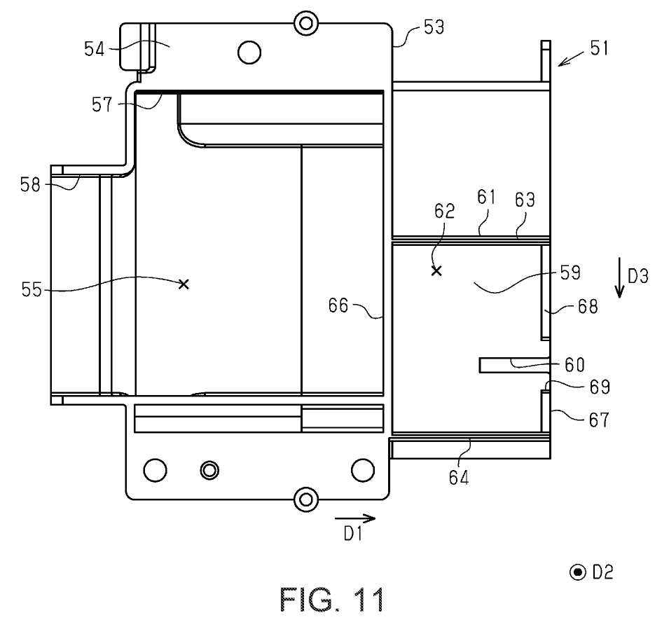

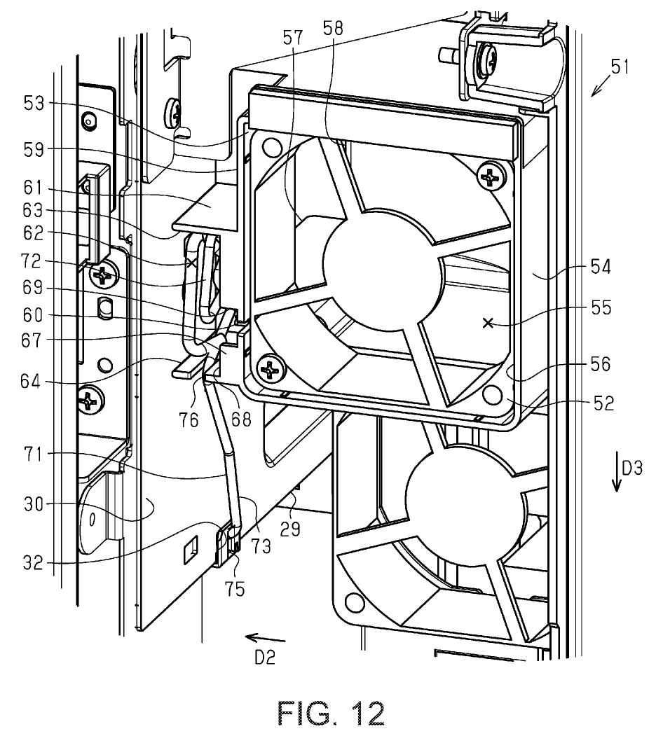

As shown in FIGS. 11 and 12, the protruding amount of the second side wall 64 may be equal to the protruding amount of the first side wall 63. In this modification, the second side wall 64 extends to contact the attachment surface 30. The storage port 76 is opened in the second side wall 64. The storage port 76 communicates with the accommodation space 62. The storage port 76 is, for example, a groove extending in the first direction D1. The harness 71 extends to the accommodation space 62 through the storage port 76. Specifically, the second cable 73 extends to the accommodation space 62 through the storage port 76. By this, the second cable 73 is held in the second side wall 64. As a result, the second cable 73 is less likely to rise up from the first frame 29.

The storage port 76 may be formed at a tip of the second side wall 64 that contacts with the attachment surface 30. The storage port 76 may be, for example, a groove extending in the second direction D2. When the tip of the second side wall 64 comes into contact with the attachment surface 30, the storage port 76 functions as a hole by the attachment surface 30 and the second side wall 64. In this case, the operator passes the harness 71 through the storage port 76 before attaching the duct 53 to the attachment surface 30.

- The accommodation space 62 is not limited to being formed by the duct 53, and may be formed in a connection target of the harness 71. That is, the accommodation space 62 may be applied to electrical components other than the blower part 51.

The liquid ejected by the recording section 21 is not limited to ink, and may be, for example, a liquid material in which particles of a functional material are dispersed or mixed in a liquid. For example, the recording section 21 may eject a liquid material including a material such as an electrode material or a pixel material used for manufacturing a liquid crystal display, an electroluminescence display, a surface emitting display, or the like in a dispersed or dissolved form.

### Technical ideas

Hereinafter, technical ideas grasped from the above embodiments and modifications, and operations and effects thereof will be described.

(A) A housing unit includes a frame, a blower part attached to the frame, a control substrate that controls the blower part, and a harness extending along the frame and connected to the control substrate and the blower part, wherein the blower part includes a fan and a duct that houses the fan, wherein the duct includes a forming portion that forms an accommodation space that houses a part of the harness together with the frame. According to the above configuration, since the extra length portion of the harness is housed in the accommodation space, the harness can be easily extended along the frame. This reduces the risk of the harness interfering with other components.

(B) The above housing unit may be such that the duct has an accommodation section that houses the fan and the forming portion is provided outside the accommodation section. According to the above configuration, since the accommodation space is a space outside the accommodation section, the air flowing by the fan is unlikely to flow into the accommodation space. This reduces the risk that the harness affects the air flow.

(C) The above housing unit may be such that the accommodation section has an opposite wall facing the frame, the forming portion includes a first side wall extending from the opposite wall so as to approach the frame and a second side wall extending from the opposite wall so as to approach the frame, the first side wall and the second side wall are opposite to each other and define the accommodation space, and the protruding amount of the second side wall is smaller than the protruding amount of the first side wall. According to the above configuration, the harness can enter the accommodation space through the space between the second side wall and the frame. At this time, the second side wall presses the harness. Since the second side wall presses the harness, the harness is less likely to rise up from the frame.

(D) The above housing unit may be such that the accommodation section has an opposite wall facing the frame, the forming portion includes a first side wall extending from the opposite wall so as to approach the frame and a second side wall extending from the opposite wall so as to approach the frame, the first side wall and the second side wall are opposite to each other and define the accommodation space, and a storage port communicating with the accommodation space is formed in the second side wall. According to the above configuration, the harness can enter the accommodation space through the storage port. At this time, the second side wall holds the harness. Since the second side wall holds the harness, the harness is less likely to rise from the frame.

(E) The above housing unit may further include a cover mounted to the frame, wherein the frame has an attachment surface to which the duct is mounted, the harness extends along the attachment surface, and the cover has an opposing member that faces the attachment surface when the cover is attached to the frame. According to the above configuration, the harness is less likely to rise from the frame, thereby reducing the possibility that the harness interferes with the opposing member. In particular, when the cover is attached to the frame, the risk of the harness coming into contact with the opposing member is reduced.

(F) The above housing unit may be such that a passageway through which the harness passes is opened in the frame, the harness extends from the passageway toward the accommodation space, and the opposing member is positioned so as to oppose the passageway. According to the above configuration, even when the harness extends between the frame and the opposing member, the operator can easily perform maintenance on the harness by pulling the harness out of the accommodation space.

(G) The above housing unit may be such that the accommodation section has an opposite wall facing the frame, the forming portion includes a first side wall extending from the opposite wall so as to approach the frame and a second side wall extending from the opposite wall so as to approach the frame, a third side wall extending from the opposite wall so as to approach the frame, and a fourth side wall extending from the opposite wall to approach the frame, the first side wall and the second side wall are opposed to each other, the third side wall and the fourth side wall face each other, the first side wall, the second side wall, the third side wall, and the fourth side wall define the accommodation space, and a protruding amount of the fourth side wall is smaller than protruding amounts of the first side wall, the second side wall, and the third side wall. According to the above configuration, the fourth side wall reduces the risk of the harness springing out from the accommodation space.

(H) The above housing unit may be such that the harness includes a first cable extending from the fan, a second cable extending from the control substrate, a relay connector connected to the first cable and the second cable and the accommodation space has a volume capable of accommodating the relay connector. According to the above configuration, the operator can easily perform maintenance on the harness by pulling out the relay connector from the accommodation space.

(I) The above housing unit may be such that the frame is a first frame, the housing unit includes a second frame, the control substrate is attached to the second frame, and the duct communicates with a space defined by the first frame and the second frame. According to the above configuration, the risk that the space defined by the first frame and the second frame will become hot can be reduced.

(J) The above housing unit may be such that a power supply substrate connected to the control substrate, wherein the frame has an attachment surface to which the duct is mounted, the power supply substrate is positioned so as to form a flow space in which air flows between the power supply substrate and the attachment surface, and the duct communicates with the flow space. According to the above configuration, the fan can cause the air in the flow space.

(K) The recording device includes the housing unit and a recording section that is housed in the housing unit and that records an image on a medium. According to the above configuration, the same effect as that of the housing unit can be obtained.

(L) The recording device includes the housing unit and a recording section that is housed in the housing unit and that records an image on a medium. According to the above configuration, the same effect as that of the housing unit can be obtained.

What is claimed is:

1. A housing unit comprising:a frame;a blower part attached to the frame;a control substrate that controls the blower part; anda harness extending along the frame and connected to the control substrate and the blower part, wherein the blower part includes a fan and a duct that houses the fan, wherein the duct includes a forming portion that forms an accommodation space that houses a part of the harness together with the frame.

2. The housing unit according to claim 1, wherein the duct has an accommodation section that houses the fan and the forming portion is provided outside the accommodation section.

3. The housing unit according to claim 2, wherein the accommodation section has an opposite wall facing the frame,
the forming portion includes a first side wall extending from the opposite wall so as to approach the frame and a second side wall extending from the opposite wall so as to approach the frame,
the first side wall and the second side wall are opposite to each other and define the accommodation space, and
the protruding amount of the second side wall is smaller than the protruding amount of the first side wall.

4. The housing unit according to claim 2, wherein the accommodation section has an opposite wall facing the frame,the forming portion includes a first side wall extending from the opposite wall so as to approach the frame and a second side wall extending from the opposite wall so as to approach the frame,the first side wall and the second side wall are opposite to each other and define the accommodation space, anda storage port communicating with the accommodation space is formed in the second side wall.

5. The housing unit according to claim 3, further comprising:a cover mounted to the frame, wherein the frame has an attachment surface to which the duct is mounted,the harness extends along the attachment surface, andthe cover has an opposing member that faces the attachment surface when the cover is attached to the frame.

6. The housing unit according to claim 5, wherein a passageway through which the harness passes is opened in the frame,the harness extends from the passageway toward the accommodation space, andthe opposing member is positioned so as to oppose the passageway.

7. The housing unit according to claim 2, wherein the accommodation section has an opposite wall facing the frame,the forming portion includes a first side wall extending from the opposite wall so as to approach the frame and
a second side wall extending from the opposite wall so as to approach the frame,
a third side wall extending from the opposite wall so as to approach the frame, and
a fourth side wall extending from the opposite wall to approach the frame,
the first side wall and the second side wall are opposed to each other,
the third side wall and the fourth side wall face each other,
the first side wall, the second side wall, the third side wall, and the fourth side wall define the accommodation space, and a protruding amount of the fourth side wall is smaller than protruding amounts of the first side wall, the second side wall, and the third side wall.

8. The housing unit according to claim 1, wherein the harness includes a first cable extending from the fan,a second cable extending from the control substrate,and a relay connector connected to the first cable and the second cable and
the accommodation space has a volume capable of accommodating the relay connector.

9. The housing unit according to claim 1, wherein the frame is a first frame,the housing unit includes a second frame,the control substrate is attached to the second frame, and the duct communicates with a space defined by the first frame and the second frame.

10. The housing unit according to claim 1, further comprising:a power supply substrate connected to the control substrate, wherein the frame has an attachment surface to which the duct is mounted,the power supply substrate is positioned so as to form a flow space in which air flows between the power supply substrate and the attachment surface, and the duct communicates with the flow space.

11. A recording device comprising: the housing unit according to claim 10 and a recording section that is housed in the housing unit and that records an image on a medium.

12. A recording device comprising: the housing unit according to claim 1 and a recording section that is housed in the housing unit and that records an image on a medium.
